(19) United States
(12) Patent Application Publication
(10) Pub. No.: US 2006/0133963 A1
(43) Pub. Date: Jun. 22, 2006

(54) Adapter for attaching information to test tubes

(75) Inventors: Israel Mayer Stein, Chestnut Hill, MA (US); Gerardus Williebrordus Giesen, Zutphen (NL); Renzo Montanari, Ravenna (IT)

Correspondence Address: KENNETH J. LUKACHER, SOUTH WINTON COURT, 3136 WINTON ROAD SOUTH, SUITE 301, ROCHESTER, NY, 14623, US

(73) Assignees: Israel Mayer Stein; Gerardus Williebrordus Giesen; Renzo Montanari

(21) Appl. No.: 11/013,859

(22) Filed: Dec. 16, 2004

(51) Int. Cl. B01L 9/00

(52) U.S. Cl. 422/99; 422/104; 422/102

(57) ABSTRACT

An adapter for test tubes is provided enabling attachment of information with identifying patient and/or test data, and which further facilitates insertion of test tubes into automated test equipment. The adapter has a cylindrical housing with two open ends into which a test tube and its attached stopper are received. In one embodiment, one end of the adapter is attached to the stopper and extends partially along the length of the test tube. In another embodiment, the adapter receives the entire test tube in a first position, and in a second position, the test tube and attached stopper are slid within the adapter housing, such that the test tube exits the housing and retains the stopper in the housing. When the assembly of the adapter and test tube is inserted into automatic test equipment, the adapter prevents the information attached to its housing associated with the sample from interfering with analysis of the sample contained in the test tube.

### FIELD OF THE INVENTION

The present invention relates to an adapter for attaching information to test tubes into which samples are receivable for conducting clinical testing, and relates particularly to an adapter which when assembled with a test tube provides a surface upon which information identifying the patient and/or test can be attached without the risk that such information will interfere with optical measurements in automated clinical analysis equipment of samples in the test tubes.

### BACKGROUND OF THE INVENTION

Test tubes are used to retain samples, such as blood drawn from patients for clinical analysis. Such sample receiving test tubes each have a closed end and an open end with a stopper providing a sealable passage through which a fluid sample may be inserted into the test tube. A typical test tube 12 with attached stopper is shown in FIG. 1, the test tube has a closed end 12a and an open end 12b onto which a stopper 14 is received. Stopper 14 is composed of rubber or rubber-like material typically used for stoppers, and provides a sealable passage through which samples are insertable, such as via a needle, into test tube 12. In the test tube example of FIG. 1, the level of the sample should be between lines 13. Procedures in identification of samples generally provide a label with information identifying the patient, such as a barcode, and patient name, and/or the test to be performed. This label denoted by 16 is attached to the test tube's outer surface, and when properly applied is located above the test tube sample when the test tube is upright. Despite training of technicians or other medical personnel, the label is often misplaced as shown by label 16′ in dashed lines. As a result, view of the sample is partially blocked by the label, causing errors and misreads when the test tube is inserted into automated analysis equipment due to improper optical sensing of sample characteristics. Such misreads may cause false readings of the sample that can result in improper patient care when relied upon by a physician. Often, labels are used which are so large that they extend too far along the length of the test tube to cover a portion of the test tube containing the sample, which similarly causes errors or false readings in automated testing equipment. Thus, it would be desirable to provide a device which prevents risk of a label attached to a test tube from interfering with analysis of samples in the test tube by automatic testing equipment.

### SUMMARY OF THE INVENTION

The principal object of the present invention is to provide an adapter for a test tube which enables secure attachment of information for positive identification, such as identifying patient and/or test data, to be associated with the sample in the test tube which avoids the risk of the attached information from interfering with analysis of the sample by automated analysis (or testing) equipment.

Another object of the present invention is to provide an adapter for a test tube which facilitates insertion of the test tube into automated analysis equipment.

Briefly described, the present invention embodies an adapter having a cylindrical housing with two open ends into which a test tube and its attached stopper are received. In a first embodiment, one end of the adapter is attached to the stopper and extends partially along the length of the test tube. In a second embodiment, the adapter receives the entire test tube in a first position, and in a second position, the test tube and attached stopper are slid within the adapter housing, such that the test tube exits the housing while retaining the stopper in the housing. Information is attachable along the outer surface of the adapter, such as a label (or tape) with identifying patient and/or testing data. The adapter when assembled with a test tube provides a mechanism the secure attachment and association of the test tube sample with information (in the form of a printed label and/or writing) for positive patient and/or test identification which prevents such information from interfering with analysis of the sample contained in the test tube when it is inserted into automatic analysis equipment, such as an erythrocyte sedimentation rate (ESR) analyzer in the case of a blood sample, or other equipment which performs other clinical analysis on samples contained in test tubes.

In the second embodiment, when the test tube is in its first position with respect to the adapter, and the test tube is surrounded by the adapter housing, thereby providing breakage protection for the test tube, which may be made of glass. While in the second position, the sample contained in the test tube is available for view when inserted into automatic analysis equipment.

The invention also embodies a method for providing an adapter for a test tube of the steps: providing a housing having a first end with a first opening and a second end with a second opening; inserting a test tube and its attached stopper through the first opening to locate the stopper at or near the first end; passing the test tube out the second opening in which the stopper is one of attached to the housing at or near the first end, or slidable between a location at or near the first end within the housing to a location within the housing at or near the second end; and placing a label upon the housing having at least information associating a sample when contained in the test tube with a patient.

### BRIEF DESCRIPTION OF THE DRAWINGS

The foregoing objects, features and advantages of the invention will become more apparent from a reading of the following description in connection with the accompanying drawings, in which:

FIG. 1 is a side view of a test tube and its attached stopper of the prior art showing both the proper position of a label and improper position of a label applied to the test tube;

FIG. 2 is a side view of the adapter of the present invention with an example of a label applied to the adapter prior to assembly of the adapter to a test tube;

FIG. 3 is a side view of the adapter of FIG. 2 when assembled with a test tube in which the label is attached to the adapter, rather than the test tube, thereby assuring label position with respect to the test tube;

FIG. 3A is another side view similar to FIG. 3 without the label in which the adapter is, for example, of a transparent clear material, showing the portion of the stopper firmly engaged with the adapter;

FIG. 4 is a cross-sectional view of the adapter along lines 4-4 of FIG. 2 without the applied label;

FIG. 5 is a cross-sectional view of the adapter along lines 5-5 of FIG. 4;

FIG. 6 is a cross-sectional view of the adapter along lines 6-6 of FIG. 4;

FIG. 7 is a top view of the adapter of FIG. 4;

FIG. 8 is a schematic diagram showing the mechanics of a typical ESR analyzer into which is received the assembled adapter and test tube of FIG. 3;

FIGS. 9 and 10 are side views of another embodiment of the adapter of the present invention, in which the test tube is shown in a first position within the adapter, and in a second position extended from the adapter, respectively; and

FIG. 11 is a schematic diagram showing the mechanics of a typical ESR analyzer into which is received the assembled adapter and test tube when in the second position of FIG. 10.

### DETAILED DESCRIPTION OF THE INVENTION

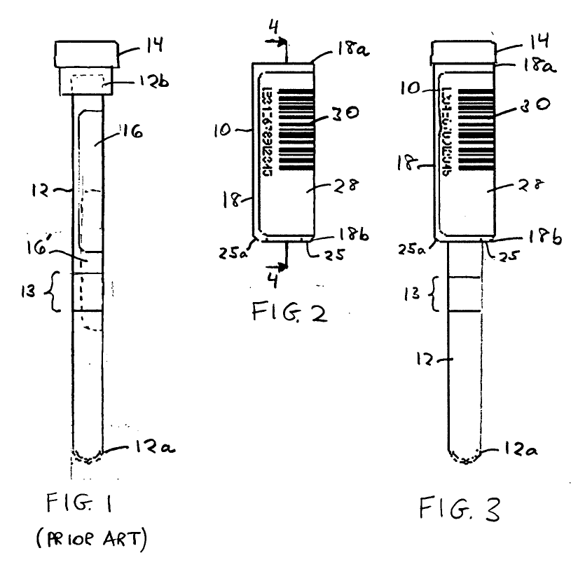

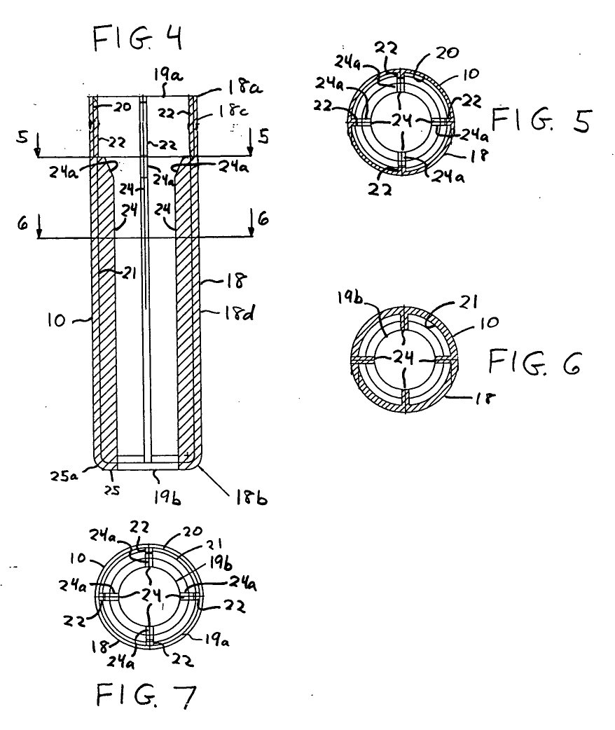

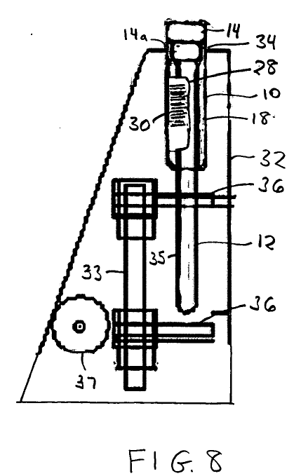

Referring to the FIGS. 2-7, an adapter 10 for a test tube 12 is shown. The adapter 10 has a cylindrical housing 18 having two ends 18a and 18b with openings 19a and 19b, respectively, through which test tube 12 is slidable into and along housing 18 until firmly engaging stopper 14. Extending from end 18a to end 18b, housing 18 has a first section 18c and second section 18d. Along section 18c is a cylindrical wall 20 having an interior with extending longitudinal ridges 22 along the length of section 18c. The interior diameter of wall 20 and ridges 22 facilitate frictional engagement of the adapter along section 18c with an annular portion 14a of stopper 14, thereby attaching adapter 10 to test tube 12 and providing the assembly thereof. Second section 18d of housing 18 has a cylindrical wall 21 having an interior with extending longitudinal guides 24 along the length of the section 18d for guiding the test tube 12 within the housing 16. For example, four ridges 22 and four guides 24 may be equally spaced radially about the interior circumference of housing 18 of their respective sections 18c and 18d. Guides 24 may each have a sloped or tapered edge 24a to facilitate loading of test tube 12 through section 18d of adapter 10, and the spacing between pairs of opposing guides 24 is slightly less than the outer diameter of test tube 12 so as provide a path along which test tube 12 may slide between the guides. Guides 24 may extend from the end of section 18c along section 18d to opening 19b, which is of a diameter slightly larger than the outer diameter of test tube 12. The diameter of the opening 19b may correspond to the distance between opposing guides 24. End 18b of housing 18 has a surface 25 about end 19b which may have rounded edge 25a. The adapter housing 18, and its ridges 22 and guides 24, may be of a single unit of molded plastic material. The plastic may be clear or opaque to light, or even of different colors. For example, adapter 10 may have the following dimensions: length of 5.28 cm, outer diameter of 1.5 cm, length along section 18c of 0.85 cm, distance between opposing ridges 22 of 1.27 cm, interior diameter along wall 20 of 1.4 cm, interior diameter along wall 21 of 13 cm, and each guide 24 of a width of 0.1 cm, but other dimensions may be used depending on the size of the test tube and stopper, and diameter of the slot into which the adapter will be received in testing equipment. When assembled to test tube 12, adapter 10 is firmly secured co-axial with the test tube, and tilt of test tube 12 within the adapter is limited by guides 24 and/or opening 19b. Although less preferable, optionally adapter 10 may be provided without ridges 22 and guides 24.

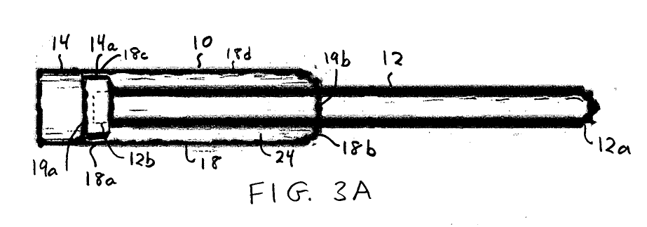

As shown in FIGS. 3 and 3A, when adapter 10 is engaged with stopper 14, the housing 18 of the adapter partially covers test tube 12. Upon the outer surface 26 of housing 18, a label (or tape) 28 may be applied with information 30 associated with the patient providing the sample when contained in test tube 12. Such information 30 may be a printed barcode and/or text (e.g., patient name, patient code or other data) positively identifying the patient, as shown in FIGS. 2 and 3. Other information 30 included on the label, may be the test to be performed, or any other information typically used with samples from patients. Label 28 may be one as conventionally used in identifying samples, and as such, the label may have an adhesive backing to fix the label to the test tube and/or a clear tape may be applied over a non-adhesive backed label to attach the label to the test tube, or other typical label attachment means may be used. Adapter 10 is shown without a label in FIG. 3A, and with label 28 in FIG. 3. The label may be attached to adapter 10 prior attachment of the adapter to a test tube, as shown in FIG. 2, or after the adapter is attached (or assembled) to the test tube 12 (i.e., adapter 10 being slid over the closed end of the test tube 12 and engaged with stopper 14 of test tube 12). The surface 26 of adapter housing 18 itself may also, or alternatively, provide a writable surface (or such surface may be applied) upon which information may be manually written upon, if desired.

The adapter 10 is especially useful for attachment to a test tube before or after a blood sample is drawn from a patient to be analyzed in an erythrocyte sedimentation rate (ESR) analyzer, such as available from Clinical Data, Inc. of Newton, Mass., USA. An ESR analyzer is an automatic instrument controlled by a microprocessor and employed for analysis of the erythrocyte sedimentation rate. Typically, multiple test tubes are received in slots of the analyzer, and each test tube is simultaneously scanned by the analyzer optical sensor(s) to provide data to the microprocessor which outputs on a display or printer the ESR value for each sample. A diagram of an example of an ESR analyzer 32 is shown in FIG. 8, which has been simplified for purposes of illustration to show the mechanics of the analyzer. The analyzer 32 has at least one slot 34 into which the assembled adapter 10 and test tube 12 is received. Slot 34 is of a diameter for receiving the adapter 10, hence adapting test tube 12 for insertion into the analyzer. The part of the test tube 12 uncovered by the adapter, denoted as 35, is available to the view of optical sensor(s) located in arms 36, which may be movable with respect to the test tube 12, such as by a motor driven gear 36 engaging a shaft 33 coupled to arms 36. As illustrated in FIG. 8, the position of adapter 10 with respect to test tube 12 is such that information 30 on label 28 cannot interfere with the view of the sample contained in the test tube 12 by sensor(s) along part 35 of test tube 12 not covered by adapter 10.

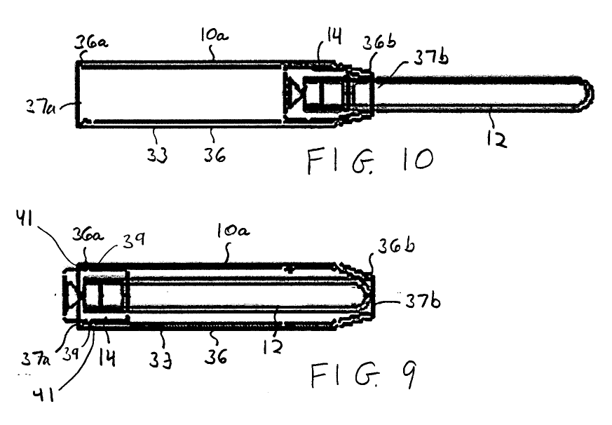

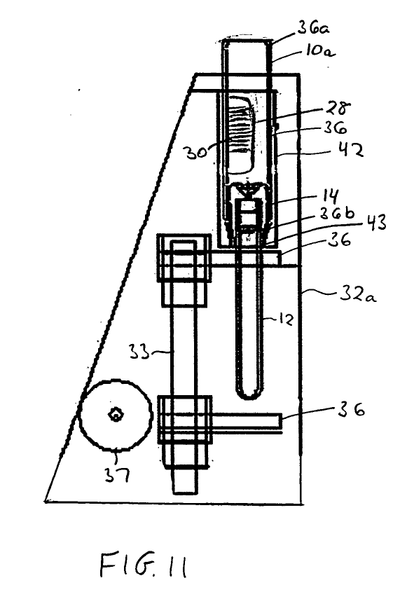

Referring to FIGS. 9 and 10, another embodiment of adapter 10 is shown denoted as adapter 10a. Adapter 10a has a cylindrical housing 36 having ends 36a and 36b with openings 37a and 37b. Ridges 22 and guides 24 of adapter 10 are not present in adapter 10a. Housing 36 has a cylindrical wall 38 with an interior diameter slightly larger than the diameter of stopper 14, such that the test tube 12 and its attached stopper 14 when located in housing are slidable within the housing. Opening 37a to housing 36 is of a diameter permitting insertion of stopper 14 and test tube 12 into the adapter 10a, while opening 37b is of a diameter enabling passage of test tube 12 there through, but not stopper 14, when the stopper 14 and test tube 12 are slid from end 36a to end 36b. This is enabled by the stopper 14 being of a larger outer diameter than the outer diameter of the test tube 12. The interior diameter of wall 38 may taper near end 36b to the smaller diameter of opening 37b enabling exiting of test tube 12 but frictionally engaging stopper 14 in housing 36 at or near end 36b. Thus, both test tube 12 and its attached stopper 14 are slidable in housing 36 between a first position when stopper is at or near end 36a and the test tube is retained in housing 36, as shown in FIG. 9, to a second position in which the test tube 12 and its attached stopper 14 are slid within housing 36 until stopper 14 engages housing 36 at or near end 36b and the test tube extends from adapter 10a, via opening 37b, as shown in FIG. 10.

In the first position, test tube 12 is contained within housing 38, while only the upper portion of stopper 14 extends from housing 36. Optionally, the entire stopper in the first position may be located in adapter 10a. In this manner, housing 36 extends substantially the length of test tube 12 and provides a surrounding enclosure, except for opening 37b, which protects the test tube from possible breakage until the test tube is inserted into automatic test equipment for analysis of the sample when contained in the test tube. Prior to such insertion, the test tube 12 is moved from its first position to its second position with respect to adapter 10a. This is achieved by pushing stopper 14 into the adapter 10a at end 36a, and then pulling test tube 12 out of the adapter, via opening 37b, until stopper 14 is stopped at or near end 36b (FIG. 10). Optionally, to maintain test tube 12 at its first position in adapter 10a, an annular ridge 39 may be provided along stopper 14 which releasably locks between tabs, detents, or ridges 41 extending from wall 38. Thus, in either the first or second positions the adapter 10a is secured to test tube 12 while being slidable co-axial with the test tube between first and second positions. A label, such as label 28, may be applied to the outside of adapter 10a, with information 30, as described earlier, such as shown for example in FIG. 11.

FIG. 11 shown an analyzer 32a, which is similar to analyzer 32 of FIG. 8, but has a slot 42 for receiving the adapter 10a when the test tube 12 in its second position in the adapter such as shown in FIG. 10. At the bottom of slot 42 is an opening 43 through which test tube 12 extends into a position with respect to sensor(s) in arms 36 to enable testing, as described earlier, so as to perform ESR measurement of a blood sample within the test tube. The position of adapter 10a with respect to test tube 12 is such that during testing its prevents information 30 on label 28 from interfering with view of the sample when contained in the test tube 12 extending from adapter 10a. Thus in the second position, the adapter 10a enables test tube 12 to be insertable into equipment for analysis of the sample contained in the test tube. After testing is complete, the adapter and assembly of the test tube 12 is removed from analyzer 32a, and the test tube is pushed back into the adapter 10a to the first position shown in FIG. 9.

Although adapters 10 and 10a have been described for use in ESR automatic test equipment, they may be used in other test equipment for performing other tests without risk of labeling (by labels or other information attaching means, e.g., writing or tape) of test tube samples interfering with testing. Further, adapter 10 and 10a allow use of any size of label without risk of obstructing normal readings of the test equipment. Further, after analysis of the sample is complete and the sample no longer need be retained, the adapter 10 or 10a is disposable along with the test tube or may be recyclable (or reusable) by removing the adapter from the test tube and removing any labeling thereupon.

From the foregoing description, it will be apparent that there has been provided an adapter for a test tube capable of receiving a sample, such as of blood or other bodily fluid from a patient. Variations and modifications in the herein described device and method in accordance with the invention will undoubtedly suggest themselves to those skilled in the art. Accordingly, the foregoing description should be taken as illustrative and not in a limiting sense.

1. An adapter for a test tube for receiving a sample having an attached stopper, said adapter comprising:
a cylindrical housing having two open ends through which said test tube is slidable into along said housing until one of said ends engages the stopper of the test tube; and
a surface along said housing for placement of at least information associated with the patient providing the sample containable in said test tube.

2. The adapter according to claim 1 wherein said one of said ends of the housing engages at least a portion of the stopper, and said housing extends partially along the length of said test tube.

3. The adapter according to claim 2 wherein the position of the adapter along the test tube prevents said information upon said housing from interfering with view of the sample when contained in the test tube.

4. The adapter according to claim 2 wherein said housing has a first section having longitudinal ridges for frictionally engaging said stopper, and a second section have longitudinal guides for guiding the test tube within the housing.

5. The adapter according to claim 1 wherein said test tube and attached stopper are slidable within said housing between a first position and a second position, in which at said first position said stopper is located at or near a first of said open ends, and in said second position said stopper is located within said housing at or near a second of said open ends and said test tube extends through said second of said open ends, and said second of said open ends represents said one of said ends that engages the stopper of the test tube.

6. The adapter according to claim 5 wherein said housing extends at least the length of said test tube.

7. The adapter according to claim 5 wherein when said test tube is at said second position the adapter prevents said information upon said housing from interfering with view of the sample when contained in the test tube

8. The adapter according to claim 5 wherein in said first position the housing protects said test tube located therein.

9. The adapter according to claim 5 wherein said test tube in said second position enables said test tube to be insertable into equipment for analysis of the sample when contained in the test tube.

10. The adapter according to claim 5 wherein said housing has means for releasable locking said stopper at said first position in said adapter.

11. The adapter according to claim 5 wherein said stopper is of a larger diameter than said test tube, and said first end of said housing has an opening of a diameter for receiving said stopper and said second end of said housing has an opening of a diameter less than said stopper for enabling exit of only said test tube.

12. The adapter according to claim 1 wherein the housing has an outer diameter adapting said test tube for insertion into equipment for analysis of the sample when contained in the test tube.

13. The adapter according to claim 1 wherein said information is provided by at least a barcode on an adhesive backed label applied to said surface of said housing.

14. The adapter according to claim 1 wherein said information further comprises information associated with the test to be performed on the sample when contained in the test tube.

15. A device for attachment to test tubes having a stopper at one end, said stopper being of a diameter larger than said test tube, said device comprising:
a housing having a first end and a second end each with openings, said test tube being receivable through said opening of said first end, and said opening of said second end is of a diameter less than said stopper and more than said test tube to enable passage of said test tube from said housing.

16. The device according to claim 15 further comprising a surface along said housing for attachment of a label capable of identifying a sample when contained in said test tube.

17. The device according to claim 15 further comprising means at said first end for attaching said housing to said test tube.

18. The device according to claim 15 further comprising means at said second end for engaging said stopper when said stopper is slid from said first end to a location at or near said second end.

19. The device according to claim 15 further comprising means within said housing for releasably engaging said stopper along one of said first end or said second end after said test tube substantially passes through said housing out said opening of said second end.

20. The device according to claim 15 further comprising a surface along said housing for attachment of information capable of identifying a sample when contained in said test tube, and said housing being positionable with respect to said test tube to prevent said information from obscuring view of the sample.

21. The device according to claim 15 wherein said housing has a shape adapted for inserting said test tube into equipment for automatic analysis of a sample when contained in said test tube.

22. The device according to claim 16 wherein said label has at least information associating a patient with the specimen when contained in said test tube.

23. A method for providing an adapter for a test tube having a stopper at one end, said method comprising the steps of:
providing a housing having a first end with a first opening, and a second end with a second opening;
inserting said test tube and attached stopper through said first opening to locate said stopper at or near said first end;
passing said test tube out said second opening in which said stopper is one of attached to said housing at or near said first end, or slidable between a location at or near said first end within said housing to a location within said housing at or near said second end; and
placing a label upon the housing having at least information associating a sample when contained in the test tube with a patient.

24. The method according to claim 23 wherein said stopper is of a diameter larger than said test tube, and said second opening is of a diameter less than said stopper and more than said test tube for enabling exit of said test tube and retaining said stopper when slid to the location within the housing at or near said second end.
